(19) United States
(12) Patent Application Publication
(10) Pub. No.: US 2023/0311727 A1
(43) Pub. Date: Oct. 5, 2023

(54) FLUID SYSTEM FOR A VEHICLE SEAT ASSEMBLY

(71) Applicant: Lear Corporation, Southfield, MI (US)

(72) Inventors: Joshua HALLOCK, Warren, MI (US); Ashley L. BAISCH, Washington Township, MI (US); Samuel BLAIR, Troy, MI (US); David ABDELLA, Royal Oak, MI (US)

(21) Appl. No.: 17/709,778

(22) Filed: Mar. 31, 2022

(51) Int. Cl. B60N 2/56; B60N 2/66; B60N 2/90; F04B 43/02

(52) U.S. Cl. CPC B60N 2/5657; B60N 2/665; B60N 2/976; B60N 2/914; F04B 43/02

(57) ABSTRACT

A seat assembly is provided with a pump for a fluid system, such as an air system. The pump has a housing with a wall surrounding a recess, with the housing defining an inlet passage and an outlet passage. A diaphragm is positioned through the wall with a distal end within the recess, and with the inlet and outlet passages in fluid communication with an opening to the pumping chamber of the diaphragm. A cam is supported for movement along a path about a central axis within the recess, and is connected to the distal end region of the diaphragm. The cam alternately moves the distal end region radially outwardly from the central axis to compress the pumping chamber and provide flow to the outlet passage, and moves the distal end region radially inwardly towards the central axis to expand the pumping chamber and provide flow into the pumping chamber.

### TECHNICAL FIELD

Various embodiments relate to a vehicle seat assembly with a fluid system having an air pump.

### BACKGROUND

Vehicle seat assemblies may be provided with air systems for seat ventilation, massage or lumbar bladders, or other seat functions, and these air systems may include an air pump. Examples of vehicle seat assemblies with air systems and pumps may be found in U.S. Pat. Nos. 10,648,464, 9,121,414, 9,452,699, Korean Patent Publication No. 101039349, Chinese Patent Publication No. 110805554, and Chinese Patent Publication No. 215979809 U.

### SUMMARY

In an embodiment, a pump is provided with a housing having a wall surrounding a recess, with the wall defining an aperture extending radially therethrough, and the housing defining an inlet passage and an outlet passage. A diaphragm extends from a lip to a distal end region, with the lip of the diaphragm defining an opening to a pumping chamber, and the diaphragm positioned with the lip adjacent to and surrounding the aperture of the wall. The distal end region of the diaphragm is positioned within the recess, and the inlet passage and outlet passage are in fluid communication with the opening to the pumping chamber. A cam is supported for movement along a path about a central axis within the recess, with the cam being connected to the distal end region of the diaphragm. The cam alternately moves the distal end region radially outwardly from the central axis and towards the wall to compress the pumping chamber and provide flow from the pumping chamber to the outlet passage, and moves the distal end region radially inwardly towards the central axis and away from the wall to expand the pumping chamber and provide flow from the inlet passage to the pumping chamber.

In a further embodiment, the housing has a first housing member forming the wall surrounding the recess, and a second housing member defining the inlet passage and the outlet passage, with the second housing member supported by the first housing member. The wall and the aperture of the first housing member are positioned between the recess and the second housing member.

In an even further embodiment, the lip of the diaphragm is positioned between the first and second housing members, and the diaphragm extends through the aperture and into the recess.

In a yet even further embodiment, the housing has a retention plate positioned between the lip of the diaphragm and the second housing member, with the retention plate engaged with the first housing member to retain the diaphragm.

In a further, yet even further embodiment, a sealing member is positioned between the retention plate and the second housing member.

In an even further, yet even further embodiment, the sealing member cooperates with the second housing member to define the inlet passage and the outlet passage.

In a yet even further, yet even further embodiment, the sealing member and the retention plate cooperate to define a first valve to control flow from the inlet passage into the pumping chamber, and a second valve to control flow from the pumping chamber to the outlet passage, the first valve and the second valve overlapping the aperture of the associated diaphragm.

In a further, yet even further, yet even further embodiment, the first valve and the second valve are each provided as a one-way valve.

In another even further embodiment, a cover cooperates with the first housing member to cover the recess.

In a yet even further embodiment, at least one spring clip cooperates with the first housing member, the second housing member, and the cover to assemble the housing.

In another further embodiment, a motor is provided with a motor shaft extending into the recess, and the motor shaft drivingly connected to the cam.

In an even further embodiment, the housing forms a second wall defining a second recess, with an end region of the motor received within the second recess. The motor shaft extends through the second wall and into the first recess.

In another even further embodiment, the path of the cam is an orbital path about a rotational axis of the motor shaft, and the rotational axis of the motor shaft coincides with the central axis.

In a further embodiment, the wall of the housing defines a second aperture therethrough, with the housing defining a second inlet passage and a second outlet passage. The pump has a second diaphragm with a second lip extending to a second distal end region and a second pumping chamber, with the second lip positioned adjacent to and surrounding the second aperture of the wall and the second distal end region positioned within the recess. The second inlet passage and the second outlet passage are in fluid communication with the second pumping chamber. The cam is connected to the second distal end region of the second diaphragm. The cam alternately moves the second distal end region radially outwardly from the central axis and towards the wall to compress the second pumping chamber and provide flow from the second pumping chamber to the second outlet passage, and moves the second distal end region radially inwardly towards the central axis and away from the wall to expand the second pumping chamber and provide flow from the second inlet passage to the second pumping chamber.

In an even further embodiment, the first inlet passage is fluidly independent of the second inlet passage. The first outlet passage is fluidly independent of the second outlet passage.

In another embodiment, a seat assembly is provided with a seating component having a duct, and a motor supported by the seating component, with the motor having a motor shaft rotating about a rotational axis. A pump is driven by the motor shaft to provide flow to the duct. The pump has a housing having a wall surrounding a recess, with the wall defining a plurality of spaced apart apertures extending radially therethrough. The housing defines at least one inlet passage and defines at least one outlet passage in fluid communication with the duct. The pump has a plurality of diaphragms, with each diaphragm forming a pumping chamber and extending from a lip to a distal end region. Each diaphragm is positioned with the lip adjacent to the wall and the distal end region within the recess. The pumping chamber of each diaphragm is in fluid communication with one of the at least one inlet passages and one of the at least one outlet passages. A plurality of inlet valves is supported by the housing, with each inlet valve being associated with a respective one of the diaphragms and overlapping the aperture associated with the respective one of the diaphragms. A plurality of outlet valves is supported by the housing, with each outlet valve being associated with a respective one of the diaphragms and overlapping the aperture associated with the respective one of the diaphragms. The pump has a cam supported for movement along an orbital path about the rotational axis within the recess. The cam is connected to the distal end region of each diaphragm. The cam alternately moves each distal end region radially outwardly from the rotational axis to compress the associated pumping chamber, and moves each distal end region radially inwardly towards the rotational axis to expand the associated pumping chamber.

In a further embodiment, the housing forms a second wall defining a second recess, with an end region of the motor received within the second recess. The motor shaft extends through the second wall and into the first recess.

In an even further embodiment, the seat component has a second duct. The seat assembly has a one-way clutch assembly driven by the motor shaft, and a fluid transfer device driven by the motor shaft via the clutch assembly. The fluid transfer device provides air flow to the second duct when the clutch assembly is engaged. The motor is positioned between the one-way clutch assembly and the pump.

In an embodiment, a method of assembling a pump for a seat assembly is provided. A diaphragm is inserted through an aperture in a wall of a first housing member until a lip of the diaphragm is adjacent to the wall and a distal end region of the diaphragm extends into a recess of the first housing member surrounded by the wall. A cam is positioned into the recess and a center of the cam is connected to a motor shaft, with the center of the cam being offset from the motor shaft. The distal end region of the diaphragm is connected to the cam for radial movement relative to a rotational axis of the motor shaft. A retention plate is positioned over the lip of the diaphragm. A sealing member is positioned over the retention plate, with the sealing member and the retention plate cooperating to form a first valve and a second valve. A second housing member is positioned over the sealing member, with the second housing member and the sealing member cooperating to define an inlet passage and an outlet passage for the diaphragm. The inlet passage overlaps the first valve, and the outlet passage overlaps the second valve. A cover is positioned over the recess. The first housing member, the second housing member, and the cover are fastened to one another to assemble the pump.

In a further embodiment, end region of a motor is positioned within a second recess defined by a second wall of the first housing member such that the motor shaft extends through the second wall and into the first recess.

### BRIEF DESCRIPTION OF THE DRAWINGS

FIG. 1 illustrates a perspective schematic view of a vehicle seat assembly according to an embodiment;

FIG. 2 illustrates a perspective view of a pump according to an embodiment and for use with the vehicle seat assembly of FIG. 1;

FIG. 3 illustrates a partial top view of the pump of FIG. 2;

FIG. 4 illustrates a side sectional view of the pump of FIG. 2; and

FIG. 5 illustrates an exploded view of the pump of FIG. 2.

### DETAILED DESCRIPTION

As required, detailed embodiments of the present disclosure are provided herein; however, it is to be understood that the disclosed embodiments are merely examples and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

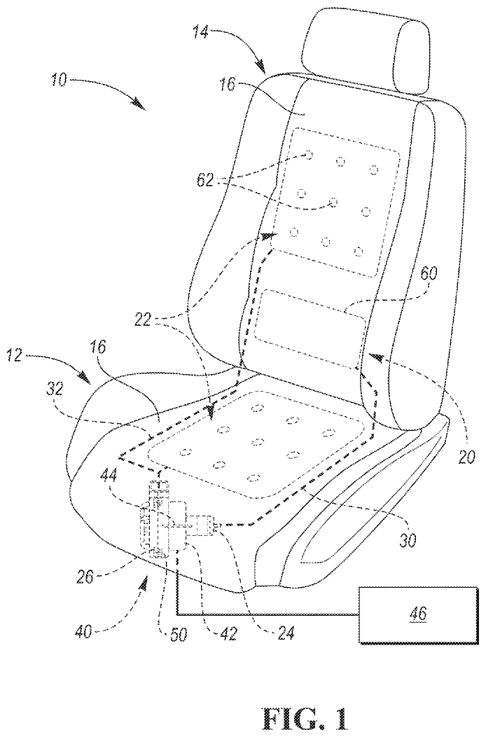

FIG. 1 illustrates a schematic perspective view of a seat assembly 10. The seat assembly 10 may be used in a vehicle as a vehicle seat assembly, for example, in a front row, or second or rear row of seating. The vehicle seat assembly 10 has one or more seating components, such as a seat base 12 or seat cushion, and a seat back 14. Each of the seating components 12, 14 may be provided with a seating surface 16. Each of the seating components may include a frame, as well as cushioning material, a trim cover, and the like.

The seat assembly 10 may be provided with various features and functions. In one example, the seat assembly has a first fluid system 20 and a second fluid system 22. The first and second fluid systems 20, 22 may be independent of one another. As used herein, fluid may refer to a gas, such as air, or a liquid. A fluid system 20, 22 may provide a massage function, for example via bladders positioned within the seating component(s); a lumbar control function with one or more bladders positioned within the seating component(s); other seat position controls with bladders appropriately positioned in the seating component(s); or a ventilation system with apertures provided through the seating surface and trim cover to provide air flow to the seat occupant. In other examples, the fluid systems may be used for other seat functions and/or features as are known in the art. In further examples, the seat assembly 10 may be provided with only a single fluid system, or with more than two fluid systems.

Each fluid system 20, 22 is provided with an associated fluid transfer device, such that there is a first fluid transfer device 24, and a second fluid transfer device 26 as shown in FIG. 1. The fluid transfer device may be a pump, an air pump, a fan, a blower, a compressor, or another rotary input device to provide flow of a fluid. Each fluid transfer device may include an impeller or similar component that is rotated to provide fluid flow. The first fluid transfer device 24 is in fluid communication with a first duct 30 supported by the seating component to provide fluid flow to the first duct and associated first fluid system 20. The second fluid transfer device 26 is in fluid communication with a second duct 32 supported by the seating component to provide fluid flow to the second duct and associated second fluid system 22. The first and second ducts 30, 32 may be provided in the same seating component, in both seating components, or in different seating components than one another.

In the example shown, the seat assembly 10 has a motor assembly 40 that has a single electric motor 42 with an output shaft. The motor 42 may be controlled to rotate the motor shaft 44 in a first direction or in a second direction opposite to the first direction, e.g. clockwise or counterclockwise, or forward or reverse. A motor controller 46 may be provided to control the direction and/or speed of the motor 42 based on an input to the controller 46 regarding operation of the first fluid system 20 or second fluid system 22. The input may be provided based on a request from the occupant. The motor assembly 40 may additionally include the first and second fluid transfer devices 24, 26.

The motor shaft 44 is connected to the first fluid transfer device 24 and the second fluid transfer device 26 to drive the first and second fluid transfer devices. A one-way clutch assembly 50 is provided in the motor assembly, and in one example, may be integrated into the housing of the second fluid transfer device 26. In a further example, and as described below with reference to FIG. 7, the motor assembly 40 may be provided with a one-way clutch assembly 50 for each of the fluid transfer devices, therefore having two one-way clutch assemblies. The clutch assembly 50 is described below in greater detail and according to various embodiments. The clutch assembly 50 is either in an engaged state or a disengaged state, with the clutch assembly 50 mechanically coupling the motor shaft 44 with the associated fluid transfer device 26 in the engaged state, and mechanically disconnecting or decoupling the motor shaft 44 from the associated fluid transfer device 26 in the disengaged state. The one-way clutch assembly 50 may operate as a momentum or acceleration based clutch, and furthermore may be silent when disengaged. The one-way clutch assembly may be passively engaged or disengaged by controlling the rotational direction of the motor shaft. In one example, the one-way clutch assembly has teeth or other engagement members that physically couple to one another when the clutch is engaged. In another example, the one-way clutch assembly may engage via a solid state or magnetic field that is generated based on the rotational direction of the motor shaft to drive an impeller of the fluid transfer device.

The first fluid transfer device 24 is driven by the motor shaft 44, and provides air flow to the first duct 30 when the motor shaft 44 rotates in the first direction. In one example, the first fluid transfer device 24 is connected for rotation with the motor shaft 44. The first fluid transfer device 24 may be driven by the motor shaft 44 rotating in either the first or second direction, and furthermore, may provide fluid flow to the first duct 30 regardless of the direction of rotation of the motor shaft 44. In this case, a valve element (not shown) may be provided in the first fluid system 20 to control fluid flow in the first system, and control the function of the first fluid system 20, e.g. by venting fluid flow to atmosphere when there is no demand for flow from the first fluid transfer device 24.

The second fluid transfer device 26 is driven by the motor shaft 44 via the one-way clutch assembly 50. The second fluid transfer device 26 provides fluid flow to the second duct 32 when the clutch assembly 50 is engaged. According to an example, the clutch assembly 50 is engaged in response to rotation of the motor shaft 44 in the first direction such that the second fluid transfer device 26 provides fluid flow to the second duct 32. The clutch assembly 50 is disengaged in response to rotation of the motor shaft 44 in the second direction such that the second fluid transfer device 26 is decoupled from the motor shaft 44 and does not provide fluid flow to the second duct 32, e.g. the second fluid system 22 is inoperative or off.

According to one example, the motor assembly 40 as shown in FIG. 1 is provided with the first fluid transfer device 24 as an air pump to provide fluid flow to at least one bladder 60 supported by the seating component via the first duct 30 of the first fluid system 20 for inflation of the bladder. Air flow to the at least one bladder 60, as well as deflation of the bladder may be controlled via one or more valve assemblies. The second fluid transfer device 26 is a fan to provide fluid flow to a series of seat ventilation apertures 62 extending through one or more seating surfaces of the seating component via the second duct 32. The motor 42 and motor shaft 44 direction may be controlled by the controller 46 to selectively engage the clutch assembly 50 and operate the second fluid transfer device 26 to provide ventilation air flow.

In other examples, the motor assembly 40 may be provided with other fluid transfer devices as the first and second fluid transfer devices, and may be used with other fluid systems of the seat assembly 10. For example, the fluid transfer device 24 may be in fluid communication with fluid system 22 via duct 32. Furthermore, the motor assembly 40 may be provided with a single motor and single fluid transfer device 24, and in fluid communication with only one fluid system, such as fluid system 22 or fluid system 20, or with more than one fluid system.

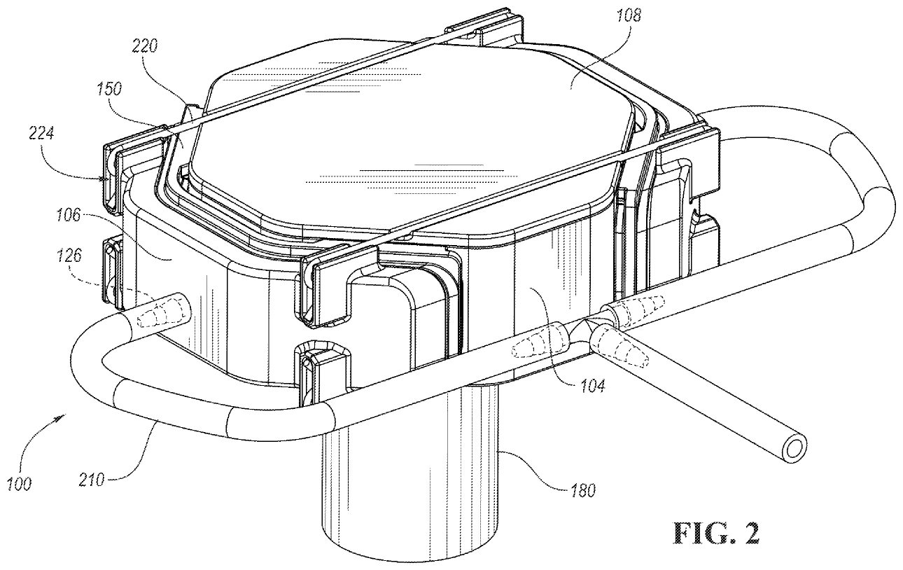

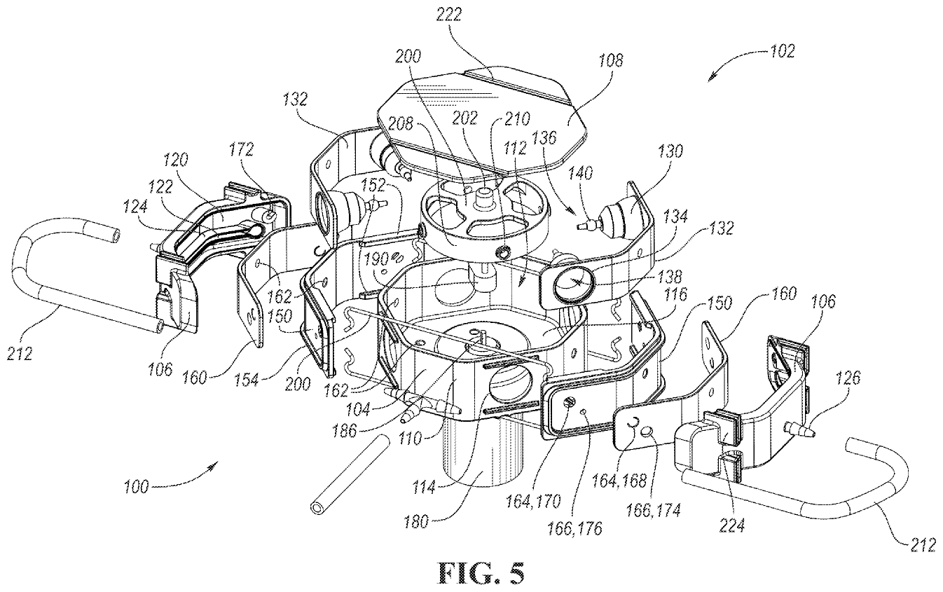

FIGS. 2-5 illustrate a pump 100 according to an embodiment. In one example, the pump 100 may be used as the first fluid transfer device 24 with the vehicle seat assembly 10 of FIG. 1 with motor assembly 40. The pump 100 may be configured to pump air to one or more fluid systems in a seat assembly 10, such as fluid system 20 or fluid system 22, or another fluid system via an associated duct.

The pump 100 has a housing 102 or housing assembly. The housing 102 is formed by a first housing member 104, a second housing member 106, and a cover 108. In other examples, the housing assembly 102 may be formed from another arrangement or number of housing members and covers.

The first housing member 104 has a first wall 110 surrounding a first recess 112, which may be configured as a central recess. The first wall 110 may entirely surround the first recess 112 as shown, and be a continuous wall 110. The first wall defines apertures 114 therethrough. The first wall 110 may be formed with multiple planar faces that are connected to one another, e.g. via curved sections, and the apertures 114 may be formed through the planar faces.

The first housing member 104 forms a second wall 116 that forms a first outer face of the pump, e.g. a lower face. The second wall 116 defines a second recess 118. The second wall 116 separates the first recess 112 from the second recess 118. The second wall 116 may be non-planar as shown to define the second recess 118. The second recess 118 is sized to receive an end region of a motor as described below.

The cover 108 cooperates with the first housing member 104 to cover or enclose the first recess 112. The cover 108 may form a second outer face of the pump 100, e.g. an upper face.

The second housing member 106 is supported by the first housing member 104, and is positioned exterior to the first wall 110, and radially outboard of the wall 110, such that the first wall and aperture(s) of the first housing member 104 are positioned radially between the first recess and the second housing member 106.

The second housing member 106 at least partially defines an inlet passage 120 and an outlet passage 122. In one example, the outlet passage 122 may be defined at least in part by a divider wall 124 that separates the outlet passage 122 from the inlet passage 120, and the inlet passage 120 may generally surround the outlet passage 122 and the divider wall 124 as shown. The divider wall 124 may be a generally transverse wall as shown. In other examples, the inlet and outlet passages 120, 122 may be otherwise formed, machined, or molded into the second housing member 106.

The second housing member 106 defines an outlet port 126 fluidly coupled to and intersecting the outlet passage 122.

In the example shown, the housing 102 has two second housing members 106 as shown. In other examples, the housing 102 may have only one second housing member, or more than two second housing members.

The pump 100 has at least one diaphragm 130. In the example shown, the pump 100 has four diaphragms 130, although fewer than four diaphragms or more than four diaphragms are also contemplated. The diaphragms 130 may be provided as pairs of diaphragms, with each pair sharing an inlet passage 120 and an outlet passage 122 as described below. Furthermore, each pair of diaphragms 130 may be formed on a substrate 132. The substrate 132 and associated diaphragms 130 may be formed from a flexible material, such as neoprene, silicone, a natural or synthetic rubber, thermoplastic elastomer, or the like.

Each diaphragm 130 extends from a lip 134 to a distal end region 136, with the lip of the diaphragm defining an opening to a pumping chamber 138. The pumping chamber 138 may extend from the lip 134 and opening to a central region of the diaphragm 130. The pumping chamber 138 may be generally cup-shaped. The lip 134 may be formed as a part of the substrate 132 for a pair of diaphragms 130. The distal end region 136 of the diaphragm may define a first retention feature 140. In one example, and as shown, the first retention feature 140 is a retention ball. Although the diaphragms 130 are shown with a circular cross-sectional shape for each pumping chamber 138, other shapes are also contemplated. Each diaphragm 130 may have a longitudinal axis that extends through the distal end region 136 and the center of the opening defined by the lip 134.

The substrate 132 and the lip 134 of the diaphragm is positioned between the first and second housing members 104, 106, with each diaphragm 130 extending through an associated aperture 114 and into the first recess 112. Each diaphragm 130 is positioned with the lip 134 adjacent to and surrounding an associated aperture 114 of the first wall 110, and with the distal end region 136 of the diaphragm positioned within the first recess 112. In one example, the substrate 132 for each pair of diaphragms 130 is positioned directly adjacent to an outer side of the first wall 110, with each diaphragm 130 extending through an associated aperture 114 in the first wall. As the substrate 132 is flexible, it can conform to the shape of the outer surface of the first wall 110. The first wall 110 is therefore positioned between the distal end region 136 of the diaphragm and the substrate 132 and associated lip 134. The substrate 132 and lip 134 may be in direct contact with the outer surface of the first wall 110. The pumping chamber 138 may be positioned such that is it substantially within the first recess 112, with substantially referring to more than fifty percent by volume of the pumping chamber, more than seventy percent of the pumping chamber by volume, or more than ninety percent of the pumping chamber by volume. The opening for each diaphragm 130 overlaps the inlet passage 120 and the outlet passage 122 for the associated second housing member 106.

The pump 100 has a retention plate 150 or retention member 150 associated with each of the second housing members 106. A retention plate 150 is therefore associated with each pair of diaphragms 130. In other examples, each diaphragm 130 may have an associated retention plate. The retention plate 150 is positioned over the substrate 132 on an external side of the substrate 132 and pair of diaphragms 130. The retention plate 150 may be shaped to follow the shape of the first wall 110, and be positioned radially outboard of the first wall 110. The retention plate 150 is positioned between the second housing member 106 and the substrate 132 and lip 134 of the diaphragm. The substrate 132 of the diaphragms is positioned between the retention plate 150 and the first wall 110 of the first housing 104. The retention plate 150 is engaged with the first housing member 104 to retain the diaphragm. In one example, the retention plate 150 has first and second flanges 152, with the first wall 110 of the first housing member received between the first and second flanges 152. The retention member may also have additional flange(s) 154 extending outwardly from an outer surface of the retention member for use in seating and retaining an associated sealing member 160 as described below.

The pump has a sealing member 160 associated with each of the second housing members 106. A sealing member 160 is therefore associated with each retention plate 150 and pair of diaphragms 130. In other examples, each diaphragm 130 may have an associated sealing member. The sealing member 160 may be formed from natural or synthetic rubber, neoprene, silicone, thermoplastic elastomer, or the like.

The sealing member 160 may be flexed or bent and shaped to follow the shape of the outer surface of the retention plate 150, and be positioned radially outboard of and in contact with the retention plate 150. The sealing member 160 is positioned between the second housing member 106 and the retention plate 150. The sealing member 160 is positioned over the retention plate 150 on an external side of the retention member, and may be engaged with the external side of the retention plate 150. In one example, and as shown, the sealing member 160 cooperates with the second housing member 106 to define and enclose the inlet passage 120 and the outlet passage 122, as each of the first and second passages 120, 122 are formed as open channels by the second housing member 106.

The inlet port 162 for each inlet passage 120 is formed by apertures through the second wall 116, the first wall 110, the retention plate, and the sealing member. Inlet air for the pump therefore flows from outside the pump 100, into the first recess 112, and to the inlet passage 120. The various apertures 162 that cooperate to collectively provide the inlet port 162 are each given the same reference number in the Figures. In an alternative example, the second housing member 106 defines at least one inlet port fluidly coupled to and intersecting the inlet passage 120, with the inlet port being adjacent to the outlet port 126.

The sealing member 160 and the retention plate 150 cooperate to define a first, inlet valve 164 to control flow from the inlet passage 120 into the pumping chamber 138, and a second, outlet valve 166 to control flow from the pumping chamber 138 to the outlet passage 122. The sealing member 160 and the retention plate 150 may define an inlet valve 164 and an outlet valve 166 for each diaphragm 130. The inlet passage 120 and outlet passage 122 are therefore in fluid communication with the opening to the pumping chamber 138 via the inlet valve and the outlet valve 166. The inlet passage 120 overlaps only the inlet valve(s) 164, and the outlet passage 122 overlaps only the outlet valve(s) 166.

The first inlet valve 164 and the second outlet valve 166 are each provided as a one-way valve. For the inlet valve 164, the sealing member 160 forms a flap 168 and the retention member forms an associated aperture 170 that allows the flap to extend into or partially through it to allow flow from the inlet passage 120 into the pumping chamber 138 of the diaphragm via the opening. The second housing member 106 forms an abutment 172 that prevents the flap 168 from opening into the inlet passage 120, and the abutment 172 therefore prevents backflow from the pumping chamber 138 into the inlet passage 120, e.g. when the diaphragm is being compressed.

For the outlet valve 166, the sealing member 160 forms a flap 174 and the retention plate 150 forms a smaller aperture 176, or other shaped or sized aperture that does not allow the flap 174 to extend through it. The flap 174 may therefore only open or move into the outlet passage 122 and into the second housing member 106 to allow flow from the pumping chamber 138 into the outlet passage 122. The small aperture 176 of the retention plate 150 therefore prevents flow from the outlet passage 122 into the pumping chamber 138 while the pumping chamber 138 is being expanded and a vacuum is being drawn. The first inlet valve 164 and the second outlet valve 166 are therefore overlapping the aperture associated with the associated diaphragm 130.

The first and second housing members 104, 106, the cover 108, and the retention plates 150 may each be formed from a plastic material, such as a thermoplastic, and may be injection molded.

In one example, a motor 180, such as an electric motor, is at least partially received within the second recess 118 of the first housing member 104. By positioning a first end region 182 of the motor 180 into the second recess 118 as shown, the overall dimension of the motor and pump 100 from the cover 108 to the second end region 184 of the motor is reduced by the depth of the second recess 118. This provides for a smaller overall motor 180 and pump 100 assembly package size.

In another example, the second wall 116 of the housing is generally planar and/or is provided without a second recess 118. As such, the first end region 182 of the motor 180 may be adjacent to, or outside of and flush against the second wall 116. The assembly 100 may be arranged in this manner, for example, when a diameter of the motor 180 casing at the first end region 182 is too large to fit within or be partially recessed within the housing 102. In this case, the overall dimension of the motor and pump 100 from the cover 108 to the second end region 184 of the motor would be the depth of the housing from the cover 108 to the second wall 116 in combination with the length of the motor between the first and second end regions.

The motor 180 is positioned such that the motor shaft 186 extends through the second wall 116 of the housing 102 and into the first recess 112. As shown, the remainder of the motor 180 may be positioned external to the housing 102. The motor shaft 186 rotates about an axis of rotation 188. The motor shaft 186 is drivingly connected to an offset member 190.

A cam 200 is connected to and driven by the motor 180 via the offset member 190. The cam 200 may be the only cam 200 provided in the pump 100 such that all of the diaphragms 130 in the pump 100 are connected to and moved by the cam 200. A center 202 of the cam may be connected to the offset member 190. The cam 200 moves along a path 204 that is offset from and spaced apart from the axis of rotation 188. The path 204 of the cam 200 may be circular or orbital, with the axis of rotation 188 in the center of the orbital path 204. The cam 200 may translate along the path 204 without moving in rotation relative to the first housing member 104. The cam 200 may be formed as a circular member, with the offset member 190 connected to the center 202 of the cam, and with the center 202 of the cam offset from the rotational axis 188 of the motor shaft, and offset from the center of the first recess 112 as defined by the first wall 110. The offset member 190 may be formed as a linkage, with one end connected for rotation with the motor shaft 186 or the cam 200, and the other end engaged with and rotating relative to the other of the motor shaft 186 or the cam 200. The offset member 190 therefore moves the cam 200 along the orbital path 204 around the axis of rotation 188. The cover 108 may define a recess 206 to receive the center 202 of the cam and help to locate the cam and define the path 204.

The cam 200 defines an outer perimeter region 208. As the cam 200 moves along one circuit of the orbital path 204, the outer perimeter region 208 of the cam sequentially approaches or gets closer to the lip 134 of each of the four diaphragms 130, and sequentially retreats from or moves farther away from the lip 134 of each of the four diaphragms 130.

The distal end region 136 of each diaphragm 130 is connected to the outer perimeter region 208 of the cam 200. The cam 200 defines a second retention feature 210 sized to cooperate with and retain the first retention feature 140. In one example, and as shown, the second retention feature 210 is a socket that receives the retention ball 140 to retain and connect the distal end region 136 of the diaphragm relative to the cam 200.

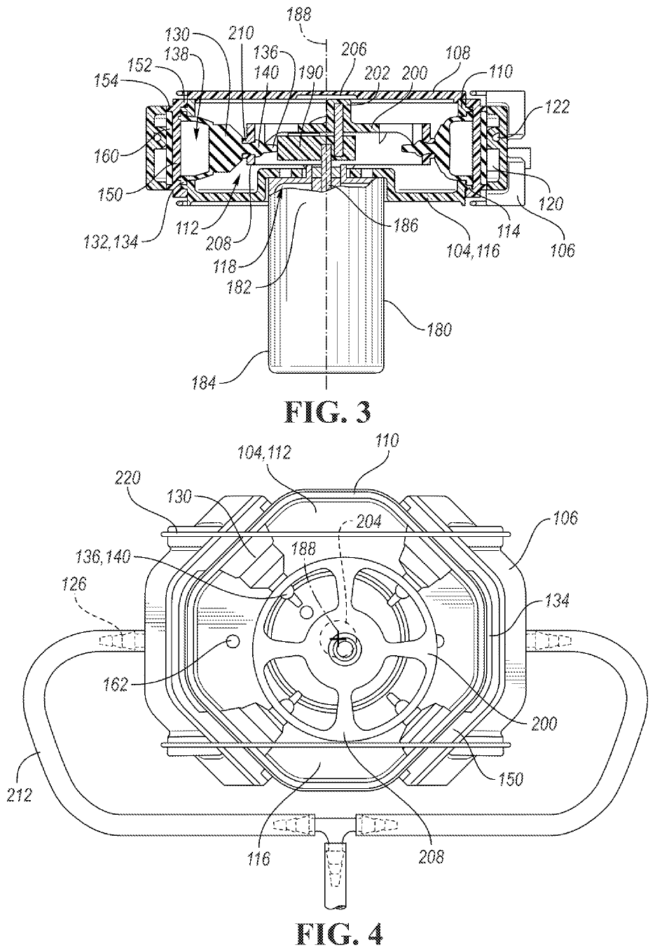

Therefore, as the cam 200 moves along its orbital path 204, the cam alternately: (i) moves the distal end region 136 radially outwardly and away from the rotational axis 188 and towards the first wall 110 to compress the pumping chamber 138 of a diaphragm and provide flow from the pumping chamber 138 to the outlet passage 122, and (ii) moves the distal end region 136 radially inwardly and towards the rotational axis 188 and away from the first wall 110 to expand the pumping chamber 138 of the diaphragm and provide flow from the inlet passage 120 to the pumping chamber 138. FIG. 4 illustrates an expanded diaphragm 130 on the left hand side, and a compressed diaphragm 130 on the right hand side. FIG. 3 illustrates an expanded diaphragm 130 at approximately the 10 o'clock position, and a compressed diaphragm 130 at approximately the 4 o'clock position. If the cam is moving clockwise about its path 204 in FIG. 3, the diaphragm 130 at approximately the 2 o'clock position is between the compressed and expanded states and moving from a compressed state to an expanded state, and the diaphragm 130 at approximately the 8 o'clock position is between the expanded and compressed states and moving from an expanded state to a compressed state.

As the pumping chamber 138 is compressed, the pressure in the diaphragm 130 is increases until the outlet valve 166 opens, and the air in the pumping chamber 138 then flows into the outlet passage 122. As the pumping chamber 138 is expanded, a vacuum is created until the inlet valve 164 opens, and air from the inlet passage 120 is then drawn into the pumping chamber 138 for the next compression cycle.

Flow from a pair of the diaphragms 130 flows into one of the outlet passages 122 via the outlet valves 166. A tube 212 or other fluid connection is connected to the outlet port 126 of the second housing 106 to receive flow from the outlet passage 122. The flow from the two outlet passages 122 may be combined via a fluid connection between two tubes 210 as shown.

Air flows into the inlet passage 120 via the inlet port 162 as described above. Air within the inlet passage 120 may flow into one of the two diaphragms 130 via the associated inlet valves 164.

The cover 108 is positioned over the first recess 112 and cooperates with the first housing member 104 to enclose the first recess 112. Spring clips 220 may be used to fasten or connect the first and second housing members 104, 106 and the cover 108 to one another to assemble the pump 100. In other examples, fasteners, such as threaded fasteners, or bolts and nuts may alternatively or additionally be used to assemble the housing 102. The first housing member 104 and the cover 108 may each form guides 222 for the spring clips 220. The second housing members 106 may each form captive features 224 for the respective ends of the spring clips 220. In the example shown, the pump 100 is provided with four spring clips 220; however, other numbers of spring clips are also contemplated.

As shown, and according to one non-limiting example, the pump 100 has a first housing member 104, two pairs of diaphragms 130, two second housing members 106, two sealing members 160, and two retention plates 150, and a cover 108. According to the example shown, the first housing member 104, the second housing members 106, the pairs of diaphragms, the retention plates 150, and the sealing members 160, and the cover 108 is mirror symmetric about a plane extending between the two pairs of diaphragms 130 and containing the axis of rotation 188. The first inlet passage of one of the second housing members 106 is fluidly independent of the second inlet passage of the other second housing member, and the first outlet passage of one of the second housing members 106 is fluidly independent of the second outlet passage of the other second housing member. The first inlet passage 120 and the first outlet passage 122 are in fluid communication with a first pair of the diaphragms 130. The second inlet passage and the second outlet passage is in fluid communication with a second pair of the diaphragms.

According to various examples, a method of assembling a pump, such as pump 100 for a seat assembly, such as seat assembly 10, is provided.

A diaphragm 130 is positioned through an aperture 114 in a first wall 110 of a first housing member 104 until a lip 134 of the diaphragm is adjacent to the first wall 110 and a distal end region 136 of the diaphragm extends into a first recess 112 of the first housing member 104 surrounded by the first wall 110. An end region 182 of a motor 180 is positioned within a second recess 118 defined by a second wall 116 of the first housing member 104 such that the motor shaft 186 extends through the second wall 116 and into the first recess 112.

A cam 200 is positioned into the first recess 112 and is drivingly connected to the motor shaft 186. The cam 200 moves about an orbital path 204 surrounding the rotational axis 188 of the motor shaft, with a center 202 of the cam being offset from the motor shaft rotational axis 188. The distal end region 136 of the diaphragm is connected to the cam 200 for radial movement relative to the rotational axis 188.

A retention plate 150 is positioned over the lip 134 of the diaphragm, and a sealing member 160 is positioned over the retention plate 150. The sealing member 160 and the retention plate 150 cooperate to form a first valve 164 and a second valve 166.

A second housing member 106 is positioned over the sealing member 160, with the second housing member 106 and the sealing member 160 cooperating to define an inlet passage 120 and an outlet passage 122 for the diaphragm 130. The inlet passage 120 overlaps the first valve 164, and the outlet passage 122 overlaps the second valve 166.

A cover 108 is positioned over the first recess 112. The first housing member 104, the second housing member 106, and the cover 108 are fastened to one another to assemble the pump 100, e.g. using spring clips 220. The outlet passage 122 is fluidly coupled to a duct of a seating component for a seat assembly 10, e.g. via tubing 212.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A pump comprising:
a housing having a wall surrounding a recess, the wall defining an aperture extending radially therethrough, the housing defining an inlet passage and an outlet passage;
a diaphragm extending from a lip to a distal end region, the lip of the diaphragm defining an opening to a pumping chamber, the diaphragm positioned with the lip adjacent to and surrounding the aperture of the wall, the distal end region of the diaphragm positioned within the recess, wherein the inlet passage and outlet passage are in fluid communication with the opening to the pumping chamber; and
a cam supported for movement along a path about a central axis within the recess, the cam being connected to the distal end region of the diaphragm, wherein, the cam alternately moves the distal end region radially outwardly from the central axis and towards the wall to compress the pumping chamber and provide flow from the pumping chamber to the outlet passage, and moves the distal end region radially inwardly towards the central axis and away from the wall to expand the pumping chamber and provide flow from the inlet passage to the pumping chamber.

2. The pump of claim 1 wherein the housing further comprises:
a first housing member forming the wall surrounding the recess; and
a second housing member defining the inlet passage and the outlet passage, the second housing member supported by the first housing member, with the wall and the aperture of the first housing member positioned between the recess and the second housing member.

3. The pump of claim 2 wherein the lip of the diaphragm is positioned between the first and second housing members, and the diaphragm extends through the aperture and into the recess.

4. The pump of claim 3 wherein the housing further comprises a retention plate positioned between the lip of the diaphragm and the second housing member, the retention plate engaged with the first housing member to retain the diaphragm.

5. The pump of claim 4 further comprising a sealing member positioned between the retention plate and the second housing member.

6. The pump of claim 5 wherein the sealing member cooperates with the second housing member to define the inlet passage and the outlet passage.

7. The pump of claim 6 wherein the sealing member and the retention plate cooperate to define a first valve to control flow from the inlet passage into the pumping chamber, and a second valve to control flow from the pumping chamber to the outlet passage, the first valve and the second valve overlapping the aperture of the associated diaphragm.

8. The pump of claim 7 wherein the first valve and the second valve are each provided as a one-way valve.

9. The pump of claim 2 further comprising a cover, the cover cooperating with the first housing member to cover the recess.

10. The pump of claim 9 further comprising at least one spring clip cooperating with the first housing member, the second housing member, and the cover to assemble the housing.

11. The pump of claim 1 further comprising a motor with a motor shaft extending into the recess, the motor shaft drivingly connected to the cam.

12. The pump of claim 11 wherein the housing forms a second wall defining a second recess, an end region of the motor received within the second recess, and wherein the motor shaft extends through the second wall and into the first recess.

13. The pump of claim 11 wherein the path of the cam is an orbital path about a rotational axis of the motor shaft, wherein the rotational axis of the motor shaft coincides with the central axis.

14. The pump of claim 1 wherein the wall of the housing defines a second aperture therethrough, the housing defining a second inlet passage and a second outlet passage;
wherein the pump further comprises a second diaphragm with a second lip extending to a second distal end region and a second pumping chamber, the second lip positioned adjacent to and surrounding the second aperture of the wall and the second distal end region positioned within the recess, wherein the second inlet passage and the second outlet passage are in fluid communication with the second pumping chamber;
wherein the cam is connected to the second distal end region of the second diaphragm; and
wherein the cam alternately moves the second distal end region radially outwardly from the central axis and towards the wall to compress the second pumping chamber and provide flow from the second pumping chamber to the second outlet passage, and moves the second distal end region radially inwardly towards the central axis and away from the wall to expand the second pumping chamber and provide flow from the second inlet passage to the second pumping chamber.

15. The pump of claim 14 wherein the first inlet passage is fluidly independent of the second inlet passage; and
wherein the first outlet passage is fluidly independent of the second outlet passage.

16. A seat assembly comprising:
a seating component having a duct;
a motor supported by the seating component, the motor having a motor shaft rotating about a rotational axis; and
a pump driven by the motor shaft to provide flow to the duct, the pump comprising:
a housing having a wall surrounding a recess, the wall defining a plurality of spaced apart apertures extending radially therethrough, the housing defining at least one inlet passage and defining at least one outlet passage in fluid communication with the duct,
a plurality of diaphragms, each diaphragm forming a pumping chamber and extending from a lip to a distal end region, each diaphragm positioned with the lip adjacent to the wall and the distal end region within the recess, wherein the pumping chamber of each diaphragm is in fluid communication with one of the at least one inlet passages and one of the at least one outlet passages,
a plurality of inlet valves supported by the housing, each inlet valve being associated with a respective one of the diaphragms and overlapping the aperture associated with the respective one of the diaphragms,
a plurality of outlet valves supported by the housing, each outlet valve being associated with a respective one of the diaphragms and overlapping the aperture associated with the respective one of the diaphragms, and
a cam supported for movement along an orbital path about the rotational axis within the recess, wherein the cam is connected to the distal end region of each diaphragm, wherein, the cam alternately moves each distal end region radially outwardly from the rotational axis to compress the associated pumping chamber, and moves each distal end region radially inwardly towards the rotational axis to expand the associated pumping chamber.

17. The seat assembly of claim 16 wherein the housing forms a second wall defining a second recess, an end region of the motor received within the second recess, wherein the motor shaft extends through the second wall and into the first recess.

18. The seat assembly of claim 17 wherein the seat component has a second duct; and
wherein the seat assembly further comprises:
a one-way clutch assembly driven by the motor shaft; and
a fluid transfer device driven by the motor shaft via the clutch assembly, wherein the fluid transfer device provides air flow to the second duct when the clutch assembly is engaged;
wherein the motor is positioned between the one-way clutch assembly and the pump.

19. A method of assembling a pump for a seat assembly, the method comprising:
inserting a diaphragm through an aperture in a wall of a first housing member until a lip of the diaphragm is adjacent to the wall and a distal end region of the diaphragm extends into a recess of the first housing member surrounded by the wall;
positioning a cam into the recess and connecting a center of the cam to a motor shaft, the center of the cam being offset from the motor shaft;
connecting the distal end region of the diaphragm to the cam for radial movement relative to a rotational axis of the motor shaft;
positioning a retention plate over the lip of the diaphragm;
positioning a sealing member over the retention plate, the sealing member and the retention plate cooperating to form a first valve and a second valve;
positioning a second housing member over the sealing member, the second housing member and the sealing member cooperating to define an inlet passage and an outlet passage for the diaphragm, the inlet passage overlapping the first valve, and the outlet passage overlapping the second valve;
positioning a cover over the recess; and
fastening the first housing member, the second housing member, and the cover to one another to assemble the pump.

20. The method of claim 19 further comprising:
positioning an end region of a motor within a second recess defined by a second wall of the first housing member such that the motor shaft extends through the second wall and into the first recess.
